(19) United States
(12) Patent Application Publication
(10) Pub. No.: US 2023/0176710 A1
(43) Pub. Date: Jun. 8, 2023

(54) DATA CURATION FOR DATA CONSUMPTION AND UTILIZATION

(71) Applicant: MISOINFO Tech., Seoul (KR)

(72) Inventors: Donguk AN, Seoul (KR); Jeongyong KANG, Seoul (KR)

(21) Appl. No.: 18/060,238

(22) Filed: Nov. 30, 2022

(30) Foreign Application Priority Data
Dec. 6, 2021 (KR) 10-2021-0172956
Dec. 13, 2021 (KR) 10-2021-0177603

(51) Int. Cl. G06F 3/0482; G06F 3/0484

(52) U.S. Cl. CPC G06F 3/0482; G06F 3/0484

(57) ABSTRACT

A data visualization method is proposed. The method may include displaying a first user interface (UI) providing a list related to a plurality of basic data on a display. The method may also include, in correspondence to a first input obtained through the first UI, displaying on a display a second UI providing a list related to a plurality of items included in first basic data corresponding to the first input among the plurality of basic data. The method may further include, in correspondence with one or more item inputs obtained through the second UI and extracting one or more sub data respectively corresponding to the one or more item inputs. The method may further include generating first visualization data based on the extracted one or more sub data, and displaying a third UI comprising the first visualization data on the display.

### CROSS-REFERENCE TO RELATED APPLICATION

This application claims priority to Korean Patent Application No. 10-2021-0172956 filed on Dec. 6, 2021, and Korean Patent Application No. 10-2021-0177603 filed on Dec. 13, 2021, both of which are incorporated herein by reference in their entirety.

### BACKGROUND

The present disclosure relates to data curation for data consumption and utilization, and more particularly, to a method and system for generating visualized data based on an item selected by a user from among various items included in data and providing the visualized data to the user.

### SUMMARY

One aspect is a data visualization method of generating visualized data based on an item by a user from selected among various items included in data and providing the visualized data to the user.

The data visualization method according to an embodiment may include displaying a first user interface (UI) providing a list related to a plurality of basic data on a display; in correspondence to a first input obtained through the first UI, displaying on a display a second UI providing a list related to a plurality of items included in first basic data corresponding to the first input among the plurality of basic data; in correspondence with one or more item inputs obtained through the second UI, extracting one or more sub data respectively corresponding to the one or more item inputs; generating first visualization data based on the extracted one or more sub data; and displaying a third UI comprising the first visualization data on the display.

The data visualization method may further include displaying an initial UI providing a list related to a plurality of categories on the display; and in correspondence to an initial input obtained through the initial UI, extracting a list related to the plurality of basic data corresponding to the initial input from among the plurality of categories.

The generating of the first visualization data may include checking data attributes of the one or more sub data; selecting a first template from among a plurality of previously stored templates based on the data attributes; and generating the first visualization data by inputting the one or more sub data into the first template.

The data attributes may include at least one of location check, numerical value check, numerical value comparison, correlation analysis of a numerical value, distribution check, and trend check.

The one or more item inputs may be implemented through a click or a drag and drop.

The plurality of basic data may be data obtained from a server of a public institution.

The plurality of previously stored templates may include at least one of a map, a graph, a distribution chart, a flowchart, text, an image, and a link.

The data visualization method may further include including the first visualization data in the plurality of basic data; displaying, on the display, a fourth UI providing a list related to the plurality of basic data including the first visualization data; and in correspondence to a second input obtained through the fourth UI, displaying, on the display, a fifth UI providing a list related to a plurality of items included in second basic data corresponding to the second input among the plurality of basic data including the first visualization data.

The plurality of items included in the second basic data may include a plurality of items included in the first basic data and one or more items corresponding to the one or more item inputs.

Another aspect is a data visualization system that may include a processor processing data; and a display outputting data processed by the processor, wherein the processor displays a first user interface (UI) providing a list related to a plurality of basic data on a display, in correspondence to a first input obtained through the first UI, displays on a display a second UI providing a list related to a plurality of items included in first basic data corresponding to the first input among the plurality of basic data, in correspondence with one or more item inputs obtained through the second UI, extracts one or more sub data respectively corresponding to the one or more item inputs, generates first visualization data based on the extracted one or more sub data, and displays a third UI comprising the first visualization data on the display.

According to an embodiment of the present disclosure, the data visualization method of generating visualized data based on the item selected by the user from among several items included in data and providing the visualized data to the user may be provided.

### BRIEF DESCRIPTION OF THE DRAWINGS

FIG. 1 is an environment diagram of a data visualization system according to an embodiment.

FIG. 2 is a flowchart of a method of generating visualization data according to an embodiment.

FIG. 3 is a flowchart of a data visualization method of generating visualization data based on an input obtained through a user interface (UI) according to an embodiment.

FIG. 4 is a flowchart of a method of generating visualization data according to an embodiment.

FIGS. 5 to 9 are examples for describing a user interface (UI) according to an embodiment.

FIG. 10 is a diagram for explaining an example of visualization data.

### DETAILED DESCRIPTION

In the reality where data analysis has been routinized, how to interpret obtained data has become more important than obtaining data. Therefore, it is necessary to provide user-customized data so that the user’s purpose may be obtained from what the user wants from the data, and only the data the user wants may be extracted and analyzed.

Since the embodiments described in the present specification are intended to clearly explain the spirit of the present disclosure to those skilled in the art, the present disclosure is not limited to the embodiments described in the present specification, and the scope of the present disclosure should be construed to include modifications or variations that do not depart from the spirit of the present disclosure.

The terms used in the present specification have been selected as a general term that is currently widely used as much as possible in consideration of the function in the present disclosure, but this may vary depending on the intention of those skilled in the art to which the present disclosure belongs, appearance of precedent or new technology, etc. However, when a specific term is defined and used in an arbitrary meaning, the meaning of the term will be separately described. Therefore, the terms used in the present specification should be interpreted based on the actual meaning of the term and the overall description of the present specification, not the simple name of the term.

The drawings attached to the present specification are for easily explaining the present disclosure, and the shapes shown in the drawings may be exaggerated as necessary to help the understanding of the present disclosure, and thus, the present disclosure is not limited by the drawings

In the case where it is determined that a detailed description of a known configuration or function related to the present disclosure in the present specification may obscure the gist of the present disclosure, a detailed description thereof will be omitted if necessary.

In the present disclosure, a data visualization system 10000 may be a system for a platform of processing, generating, and/or distributing data. That is, the data visualization system 10000 may be referred to as a data distribution platform below.

Also, in the present disclosure, a method of generating visualization data may be a method of generating metadata describing the data. Visualization data may mean metadata describing data. Specifically, the visualization data may be metadata including analysis of data obtained by comparing or analyzing data obtained by a server 1000. That is, the method of generating visualization data may be referred to as a method of generating metadata below.

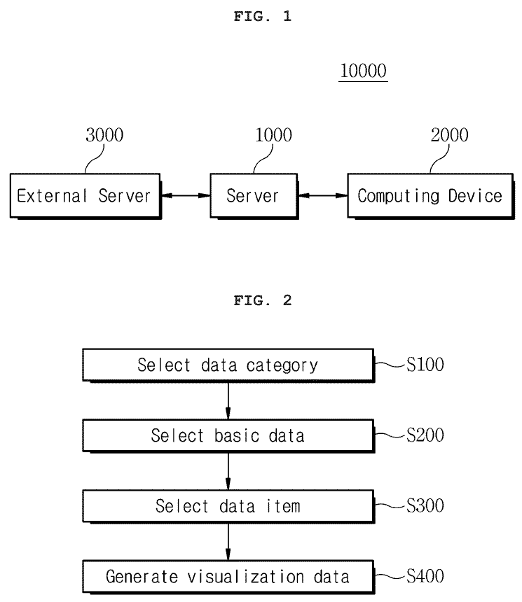

FIG. 1 is an environment diagram of a data visualization system according to an embodiment.

Referring to FIG. 1, the data visualization system 10000 may include the server 1000, a computing device 2000, and an external server 3000. That is, a data distribution platform may be implemented by the server 1000, the computing device 2000 and the external server 3000.

FIG. 1 shows only one computing device and one external server communicating with the server 1000, but is not limited thereto, and the server 1000 may communicate with two or more computing devices and external servers. In addition, only one server 1000 is shown in FIG. 1, but is not limited thereto, and a plurality of servers may exist according to respective functions thereof.

In addition, the computing device 2000 and the external server 3000 are illustrated as communicating through the server 1000 in FIG. 1, but are not limited thereto, and the server 1000, the computing device 2000, and the external server 3000 may communicate directly with each other.

The server 1000 is a central component of the data visualization system 10000, and may serve as an overall control unit of the data visualization system 10000.

The server 1000 may be connected to the computing device 2000 and the external server 3000. In addition, the server 1000 may be connected to the computing device 2000 and the external server 3000 to exchange communication signals.

The server 1000 may include a control unit, a communication unit, a storage unit, an output unit, etc. Below, the corresponding components will be described, but the corresponding components are not indispensable, and the server 1000 may have more or fewer components. In addition, each component of the server 1000 may be physically included in one server or may be a distributed server distributed for each function.

The control unit may generalize the operation of the server 1000. Specifically, the control unit may execute the operation of each unit by sending control commands to the communication unit and the storage unit. Also, the control unit may analyze and/or generate data. In the present specification, the control unit may also be referred to as a processor.

In the following, unless otherwise specified, the operation of the server 1000 may be interpreted as being performed under the control of the control unit or the processor.

The communication unit may connect the server 1000 and an external device to communicate with each other. That is, the communication unit may transmit/receive data with the external device. For example, the communication unit may exchange data with the computing device 2000 or the external server 3000.

According to an embodiment, the communication unit may receive user information from the computing device 2000. Also, the communication unit may receive a signal corresponding to a user’s input for a specific item from the computing device 2000.

According to an embodiment, the communication unit may obtain a plurality of data from the external server 3000. In this regard, the plurality of data may include data that may be analyzed, such as statistical numerical data, maps, trends, etc.

The data obtained by the communication unit from the external server 3000 is raw data, and the processor of the server 1000 may process the raw data into a form that may be analyzed. For example, the server 1000 may pre-process the raw data before analyzing the raw data, such as matching the raw data to a specific format or changing the size of the data.

The communication unit may be a communication module supporting at least one of a wired communication method and a wireless communication method.

For example, the communication unit may obtain data from an external device through communication methods such as Bluetooth, Zigbee, Bluetooth Low Energy (BLE), RFID, etc.

The storage unit of the server 1000 may store various data and programs necessary for the server 1000 to operate. The storage unit may store information obtained by the server 1000.

For example, the storage unit may store information received from the computing device 2000 obtained by the communication unit. In addition, the storage unit may store various data received from the external server 3000 obtained by the communication unit.

The storage unit may temporarily or semi-permanently store data. Examples of the storage unit may include a hard disk drive (HDD), a solid state drive (SSD), a flash memory, a read-only memory (ROM), a random access memory (RAM), or cloud storage. (Cloud Storage), etc. However, the storage unit is not limited thereto, and may be implemented as various modules for storing data.

The storage unit may be provided in a form embedded in the server 1000 or in a detachable form.

The output unit included in the server 1000 may output information. In the present specification, the output unit may also be referred to as a display. Specifically, the output unit may output data processed or generated by the control unit. The output unit may output information visually, audibly, or tactilely, but is not limited thereto, and may have various types of output.

The computing device 2000 may be a device of a user who uses the data visualization system 10000. Specifically, the computing device 2000 may be a user terminal or a server of a user’s computer. Although only one computing device 2000 is shown in FIG. 1, a plurality of users may use the data visualization system 10000 by communicating with each other through respective computing devices or communicating with the server 1000.

According to an embodiment, the plurality of users may exchange data through respective computing devices. For example, each user may transfer or sell visualization data generated by the server 1000. Alternatively, each user may transfer or sell visualization data generated by the server 1000 to the external server 3000.

The external server 3000 may be a device providing necessary data to the data visualization system 10000. The external server 3000 may be a server of a public institution or a server of a private company. That is, the server 1000 may obtain data of the public institution through the external server 3000, or obtain data of the private company through the external server 3000. Also, the server 1000 may transmit the generated visualization data to the external server 3000.

FIG. 2 is a flowchart of a method of generating visualization data according to an embodiment.

Referring to FIG. 2, the method of generating visualization data may include selecting a data category (S100), selecting basic data (S200), selecting a data item (S300), and generating visualization data (S400). The server 1000 may generate metadata describing data through steps S100, S200, S300 and S400.

Step (S100) of selecting the data category may be a step in which a user of the computing device 2000 selects one category from among a plurality of categories provided by the server 1000.

Specifically, the server 1000 may obtain a plurality of data from the external device 3000. The server 1000 may classify the plurality of obtained data according to categories. The server 1000 may classify the plurality of data according to fields. In this regard, the category may be data related to sports, data related to traditional markets, data related to weather, data related to price, data related to company information, etc.

For example, the data related to sports may include data related to soccer, baseball, basketball, volleyball, etc. Also, for example, the data related to traditional markets may include data related to traditional markets in each region, such as a Seoul traditional market, a Gyeonggi-do traditional market, and a Gangwon-do traditional market.

In addition, the category may include data regarding sports fields, sports goods, companies related to sports, sports players, etc., and external public data such as weather that may be with the data. In this regard, the external public data may be public data obtained from the external server 3000.

Also, for example, the data related to weather may include data related to temperature, precipitation, humidity, fine dust, etc. Also, for example, the data related to company information may include data related to employment rate, resignation rate, annual salary, operating profit, etc.

Step (S200) of selecting the basic data may be a step in which the server 1000 provides the basic data included in the category selected in step S100 to the user, and the user selects one of the basic data.

Specifically, the basic data may be more detailed information within the category selected in step S100. The basic data may be data related to the purpose for which the user wants to visualize data.

For example, when the user selects a sports category, a plurality of basic data may include data classified for each sports event. That is, in the example, the user may select basic data corresponding to any one event among soccer, baseball, basketball, and volleyball.

In addition, for example, when the user selects a traditional market category, the plurality of basic data may include data classified according to the purpose, such as classified per location of a traditional market or for the purpose of guiding the traditional market.

In addition, for example, when the user selects a weather category, the plurality of basic data may include data classified according to the purpose, such as classified per season or per specific temperature, or classified as data related to weather prediction.

In addition, for example, when the user selects a company information category, the plurality of basic data may include data classified according to the purpose such as classified as data for employment or classified as data for merger.

Step (S300) of selecting the data item may be a step in which the server 1000 provides the plurality of items included in the basic data selected in step S200 to the user, and the user selects one or more items among plurality of items.

Specifically, the data item may be an item of data included in the basic data selected in step S200. The data item selected in step S300 may be an item selected by the user to generate visualization data.

For example, when the user selects basic data related to soccer, a plurality of data items may include items such as country, soccer team name, soccer player, position, ranking, etc.

In addition, for example, when the user selects basic data related to guidance of the traditional market, the plurality of data items may include items such as market area, number of business stores, number of markets, market locations, restroom information, parking lot information, etc.

Also, for example, when the user selects basic data related to temperature, the plurality of data items may include items such as temperature, date, season, and region.

In addition, for example, when the user selects basic data related to employment, the plurality of data items may include items such as company name, representative, company location, number of employees, establishment year, annual salary, etc.

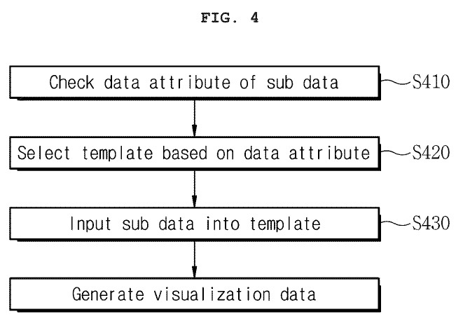

Step (S400) of generating visualization data may be a step of generating visualization data based on the data item selected in step S300. A detailed description of this will be described below with reference to FIG. 4.

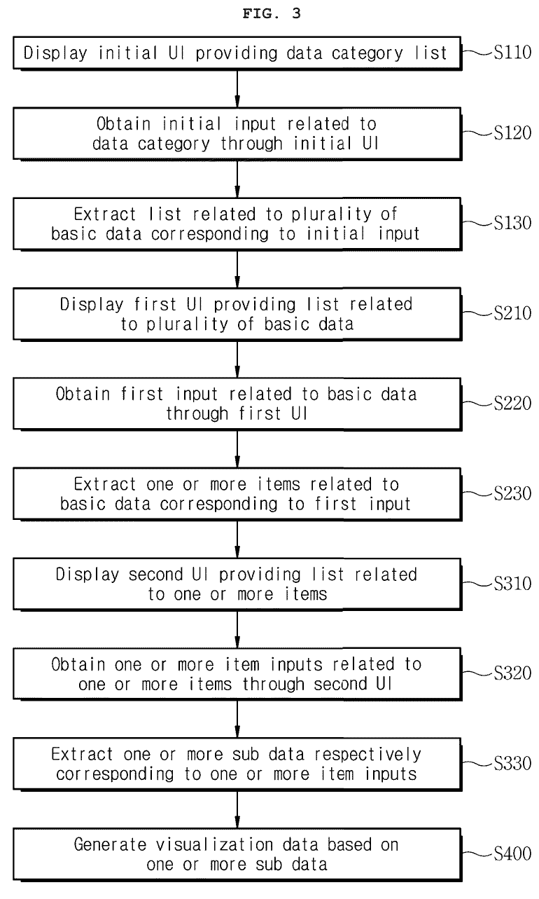

FIG. 3 is a flowchart of a data visualization method of generating visualization data based on an input obtained through a user interface (UI) according to an embodiment. FIG. 3 is a diagram for explaining the order of FIG. 2 in association with the UI. That is, FIG. 3 is a diagram for specifically explaining FIG. 2.

The data visualization method of generating visualization data based on the input obtained through the UI according to an embodiment may include displaying an initial UI providing a data category list (S110), obtaining an initial input related to a data category through the initial UI (S120), and extracting a list related to a plurality of basic data corresponding to the initial input (S130)

In addition, the data visualization method of FIG. 3 may include displaying a first UI providing the list related to the plurality of basic data (S210), obtaining a first input related to the basic data through the first UI (S220), and extracting one or more items related to the basic data corresponding to the first input (S230).

In addition, the data visualization method of FIG. 3 may include displaying a second UI providing a list related to the one or more items (S310), obtaining one or more item inputs related to the one or more items through the second UI (S320), and extracting one or more sub data respectively corresponding to the one or more item inputs (S330).

In addition, the data visualization method of FIG. 3 may include generating visualization data based on the one or more sub data (S400), which may be the same as generating visualization data (S400) of FIG. 2.

Step (S110) of displaying the initial UI providing the data category list may be a step of outputting a plurality of category lists on a display so that the user may select a category. In this regard, the display may be a display of the computing device 2000 or a display of the server 1000.

Specifically, the initial UI may include a category selection column. When the user clicks the category selection column, the server 1000 may display the plurality of category lists through the column.

Step (S120) of obtaining the initial input related to the data category through the initial UI may be a step in which that the server 1000 obtains an initial input related to a specific category when the user selects the specific category from a category selection column included in the initial UI. Specifically, the server 1000 may receive a signal including information about the selected category from the computing device 2000.

In this regard, the initial input may be made in the form of the user clicking a part where the specific category is written. However, the initial input is not limited thereto, and may be made in other input forms such as a drag and drop in addition to a click.

Step (S130) of extracting the list related to the plurality of basic data corresponding to the initial input may be a step in which the server 1000 extracts a plurality of basic data lists included in a category corresponding to the initial input, based on the initial input obtained in step S120.

For example, when the user selects a category related to sports, the server 1000 may extract the plurality of basic data lists including data related to soccer, baseball, basketball, volleyball, etc. included in the sports category in step S130.

Step (S210) of displaying the first UI providing the list related to the plurality of basic data may be a step of providing the plurality of basic data lists extracted in step S130 to the user. Step S210 may be a step of outputting the plurality of basic data lists on the display so that the user may select basic data.

Specifically, the first UI may include a basic data selection column. When the user clicks the basic data selection column, the server 1000 may display the plurality of basic data lists through the column.

Step (S220) of obtaining the first input related to the basic data through the first UI may be a step in which the server 1000 obtains a first input related to specific basic data when the user selects the specific basic data from the basic data selection column included in the first UI. Specifically, the server 1000 may receive a signal including information about the selected basic data from the computing device 2000.

In this regard, the first input may be made in the form of the user clicking a part where the specific basic data is written. However, the first input is not limited thereto, and may be made in other input forms such as a drag and drag, etc. in addition to the click.

Step (S230) of extracting the one or more items related to the basic data corresponding to the first input may be a step in which the server 1000 extracts a plurality of items included in the basic data corresponding to the first input, based on the first input obtained in step S220.

For example, when the user selects basic data related to guidance of the traditional market, the plurality of items may extract a plurality of item lists including items such as market area, number of business stores, number of markets, market locations, restroom information, parking lot information, etc.

Step (S310) of displaying the second UI providing the list related to the one or more items may be a step of providing the one or more items extracted in step S230 to the user. Step S310 may be a step of outputting one or more item lists to the display so that the user may select one or more items.

Specifically, the second UI may include an item selection column in which the plurality of items are listed. Even if the user clicks or does not click the item selection column, the server 1000 may display the plurality of item lists through the column.

Step (S320) of obtaining the one or more item inputs related to the one or more items through the second UI may be a step in which the server 1000 obtains an item input related to a selected item when the user selects the one or more items in the item selection column in which the plurality of items included in the second UI are listed. Specifically, the server 1000 may receive a signal including information about the one or more selected items from the computing device 2000.

In this regard, the item input may be made in the form of a user clicking a part where the specific basic data is written. However, the item input is not limited thereto, and may be made in other input forms such as a drag and drop in addition to the click.

Step (S330) of extracting the one or more sub data respectively corresponding to the one or more item inputs may be a step in which the server 1000 extracts the one or more sub data based on the one or more item inputs obtained in step S320.

For example, when the user selects items of the market area and the traditional market location, the server 1000 may extract first sub data including market area data for each traditional market and second sub data including location information for each traditional market.

Step (S400) of generating visualization data based on the one or more sub data will be described in detail below with reference to FIG. 4.

FIG. 4 is a flowchart of a method of generating visualization data according to an embodiment.

Referring to FIG. 4, the method of generating visualization data may include checking data attribute of sub data (S410), selecting a template based on the data attribute (S420), inputting the sub data into the template (S430), and generating visualization data (S440).

Step (S410) of checking the data attribute of the sub data may be a step of checking attribute of the sub data extracted in step S330 in order to select the template of visualization data. Specifically, the data attribute of the sub data may include at least one of location check, numerical value check, numerical value comparison, correlation analysis of numerical value, distribution check, and trend check.

For example, when the sub data is market area data of a traditional market, the user may check an area value of each market through the market area data of the traditional market. Therefore, the attribute of the area data of the traditional market may be numerical value check.

Also, for example, when the sub data is location data of a traditional market, the user may check the geographical location of the market through the data. Therefore, the attribute of the location data of the traditional market may be location check.

In the above example, when the user selects the area of the traditional market and the location of the traditional market as items of basic data, attributes of sub data corresponding to the selected items may be location and numerical value check.

For another example, when the sub data is the performance of a soccer player, the user may compare and check a numerical value corresponding to the performance of each soccer player through performance data of the soccer player. Therefore, attributes of the performance data of the soccer player may be numerical value check and numerical value comparison.

Step (S420) of selecting the template based on the data attribute may be a step of selecting one or more templates from among a plurality of previously stored templates based on the data attribute checked in step S410.

The plurality of templates stored in the server 1000 may include at least one of a map, graph, distribution chart, flowchart, text, image, and link. In this regard, the graph may be in various forms such as a bar graph or a circular graph, and the shape of the graph may be determined according to the attribute of data or a user’s selection.

For example, when the attribute of data is location check, the server 1000 may select a map from among the plurality of templates as the template of visualization data. Also, for example, when the attribute of data is numerical value comparison, the server 1000 may select a graph from among the plurality of templates as the template of visualization data.

Also, for example, when the attribute of data is distribution check, the server 1000 may select a distribution map as the template of visualization data. In addition, when the attributes of the data are location check and numerical value check, the server 1000 may select a map and a graph as templates of the visualization data. That is, the server 1000 may combine templates according to the data attributes.

Step (S430) of inputting the sub data into the template may be a step of inputting sub data corresponding to an item selected by the user into the template selected in step S430. The sub data corresponding to the item selected by the user may be sub data extracted in step S330.

For example, when items selected by the user are the area of the traditional market and the location of the traditional market, the server 1000 may select a map as the template, and apply location data of the traditional market and area data of the traditional market to the map template in step S430.

Also, for example, when the item selected by the user is performance of a soccer player, the server 1000 may select a graph as the template and apply data related to the performance of the soccer player to the graph template.

Step (S440) of generating visualization data may be a step of generating visualization data to be provided to the user based on the sub data applied to the template through step S430. Visualization data may be generated by performing step S430, or may additionally consider other user inputs.

In this regard, user’s other inputs may be inputs related to a font, font size, character arrangement, etc. That is, when the server 1000 generates initial visualization data in step S430, the user may modify the initial visualization data to suit his/her own purpose and finally generate visualization data.

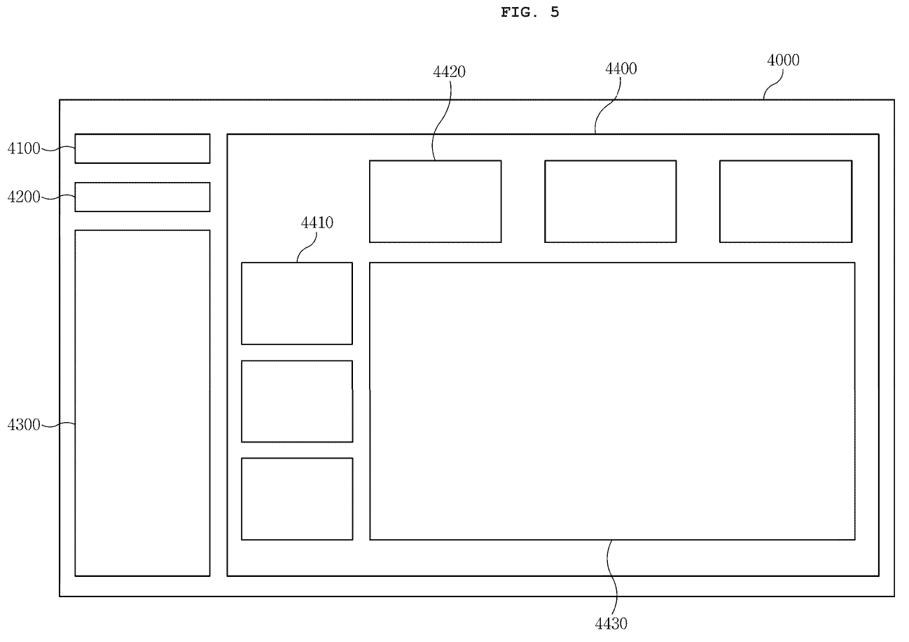

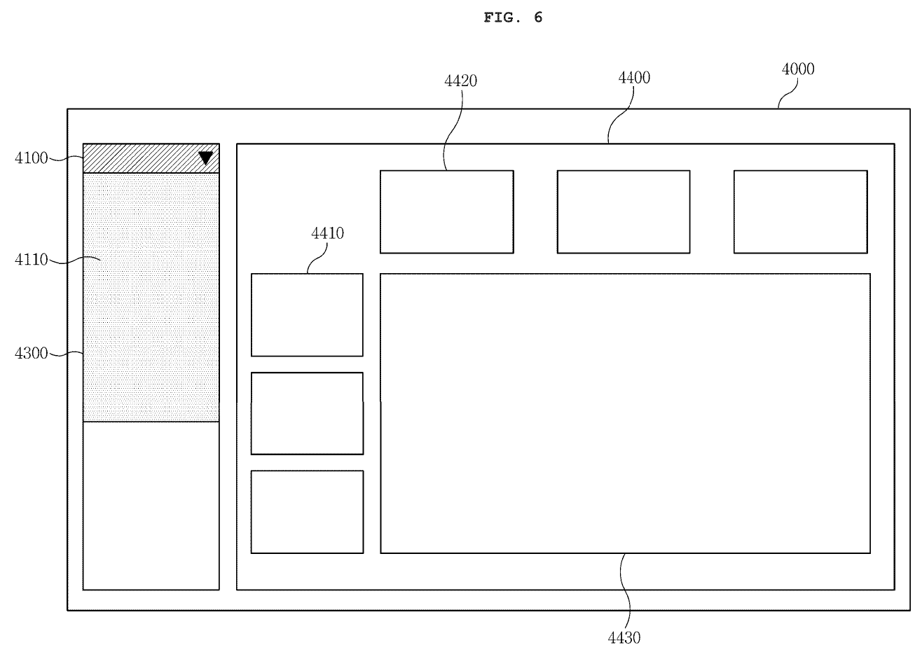

FIGS. 5 to 9 are examples for describing a UI according to an embodiment.

Referring to FIG. 5, a UI 4000 including a plurality of frames may be identified. The UI 4000 may be output through a display.

The UI 4000 provided by the server 1000 may include a category selection column 4100, a basic data selection column 4200, an item selection column 4300, and a visualization data generation column 4400.

The category selection column 4100 may be referred to as a first frame. The user may click the first frame 4100 to select one category from among a plurality of category lists provided by the server 1000.

The basic data selection column 4200 may be referred to as a second frame. The user may click the second frame 4200 to select one basic data from among a plurality of basic data lists provided by the server 1000. In this case, the plurality of basic data lists may be changed according to a user’s input obtained through the first frame 4100.

The item selection column 4300 may be referred to as a third frame. The user may select one or more data items from among a plurality of data items provided by the server 1000 through the third frame 4300. In this case, the plurality of data items may vary according to ae user’s input obtained through the second frame 4200.

The visualization data generation column 4400 may be referred to as a fourth frame. The user may be provided with visualization data through the fourth frame 4400.

The fourth frame 4400 may include a first sub frame 4410, a second sub frame 4420, and/or a third sub frame 4430. However, this is not limited thereto, and the first sub frame 4410, the second sub frame 4420, and the third sub frame 4430 may be implemented as a fifth frame, a six frame, or a seventh frame in a single frame in the UI 4000 without being included in the fourth frame.

The user may input an item to be implemented as visualization data in the first sub frame 4410. For example, the user may click and select an item from the third frame 4300 or may input the item in the drag and drop form of dragging an item of the third frame 4300 to the first sub frame 4410.

The user may input a template to be implemented as visualization data in the second sub frame 4420. For example, the user may click and select a specific template on a template selection screen (not shown) among screens included in the UI 4000, or may input the template in the drag and drop form of dragging the specific template to the second sub frame 4420.

The server 1000 may generate visualization data based on items and templates input through the first sub frame 4410 and the second sub frame 4420. The server 1000 may provide the generated visualization data to the user through the third sub frame 4430. That is, the server 1000 may output the UI 4000 including the third sub frame 4430 in which visualization data is displayed to the display.

Referring to FIG. 6, a UI when the user selects the first frame 4100 may be identified.

When the user selects the first frame 4100, the server 1000 may generate a list column 4110 adjacent to the first frame 4100 and provide a category list to the user.

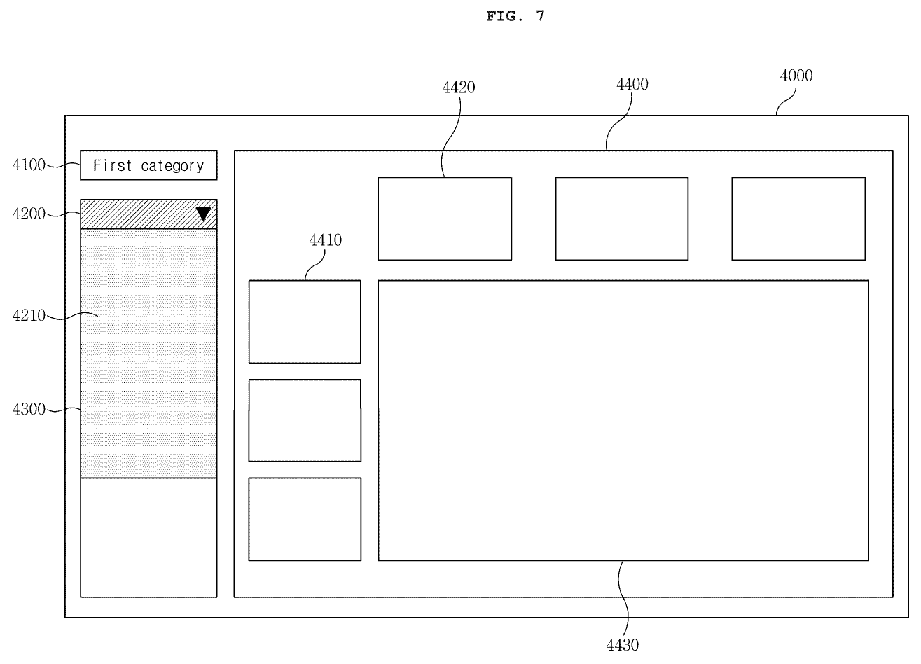

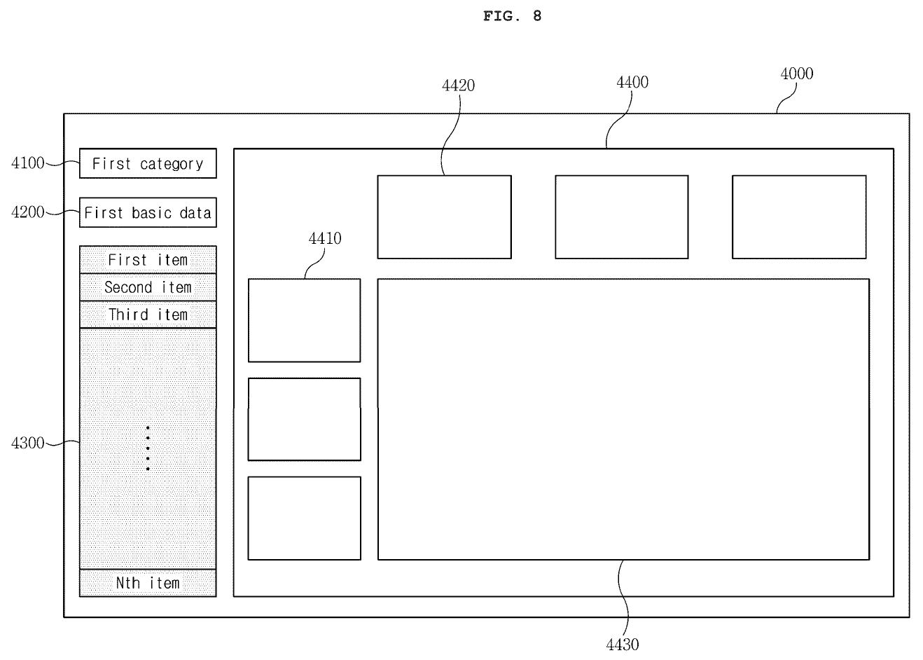

Referring to FIG. 7, when the user selects the second frame 4100, a UI may be identified.

When the user selects the second frame 4200, the server 1000 may generate a list column 4210 adjacent to the second frame 4200 and provide a basic data list to the user.

Referring to FIG. 8, a UI providing a plurality of data items may be identified.

When the user selects basic data in FIG. 7, the server 1000 may provide a plurality of item lists corresponding to the basic data through the third frame 4300.

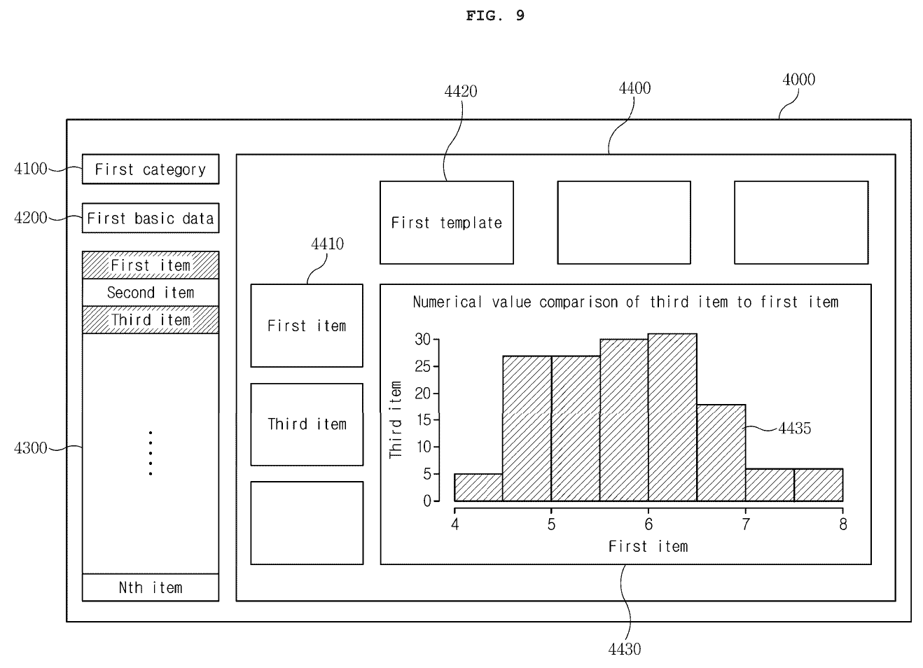

Referring to FIG. 9, a UI that outputs visualization data may be identified based on an item selected by the user.

When the user selects one or more items in FIG. 8, the server 1000 may generate visualization data 4435 based on one or more sub data corresponding to the one or more items. Specifically, the server 1000 may generate visualization data 4435 by selecting a template according to data attributes of one or more sub data and applying the one or more sub data to the template. The server 1000 may provide the generated visualization data 4435 through the third sub frame 4430.

For example, when the user selects a first item and a third item among a plurality of items, the server 1000 may generate the visualization data 4435 by applying first sub data corresponding to the first item and third sub data corresponding to the third item to the first template. The server 1000 may output a UI including the first visualization data 4435 to the display.

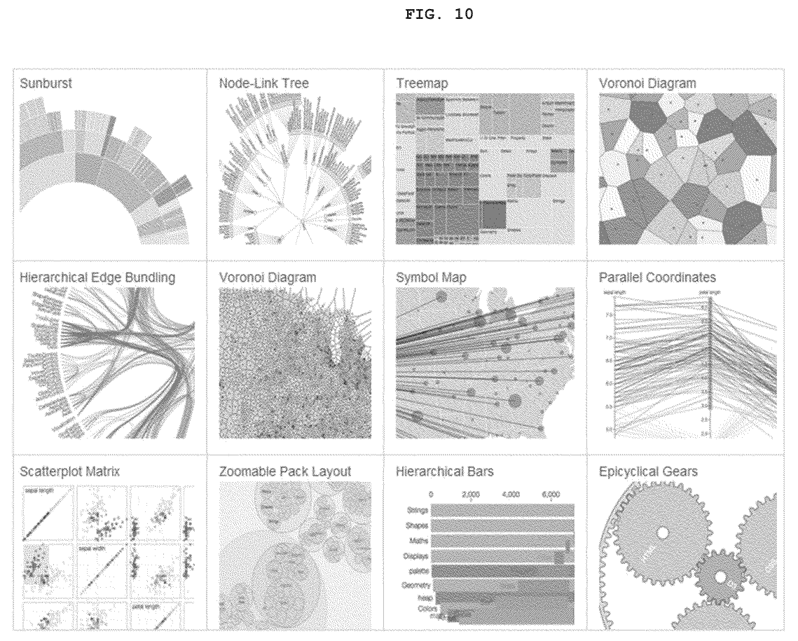

FIG. 10 is a diagram for explaining an example of visualization data.

Referring to FIG. 10, visualization data may have various forms according to a user’s purpose.

For example, when the user’s purpose is to compare measurement values of two or more items, the server 1000 may generate visualization data for comparing numerical values through a graph.

Also, for example, when the user’s purpose is to check information through a map, the server 1000 may generate visualization data displaying location and information on the map.

Also, for example, when the user’s purpose is to analyze a trend, the server 1000 may generate visualization data including a time-series graph.

That is, the present disclosure relates to a method of generating metadata that may explain public data through the obtained public data. As shown in FIG. 10, the format and contents of the metadata may vary depending on the obtained public data.

The method according to the embodiment may be implemented in the form of program instructions that may be executed through various computer means and recorded on a computer readable medium. The computer readable medium may include program instructions, data files, data structures, etc. alone or in combination. The program instructions recorded on the medium may be specially designed and configured for the embodiment or may be known and usable to those skilled in computer software. Examples of the computer readable medium include magnetic media such as hard disks, floppy disks and magnetic tapes, optical media such as CD-ROMs and DVDs, magneto-optical media such as floptical disks, and a hardware device specially configured to store and execute program instruction, such as ROM, RAM, flash memory, etc. Examples of program instructions include high-level language codes that may be executed by a computer using an interpreter, as well as machine language codes such as those produced by a compiler. The hardware device described above may be configured to operate as one or more software modules to perform the operations of the embodiments, and vice versa.

As described above, although the embodiments have been described with limited embodiments and drawings, those skilled in the art may make various modifications and variations from the above description. For example, even if the described techniques are performed in an order different from the method described, and/or components of the described system, structure, device, circuit, etc. are coupled or combined in a different form from the method described, or are replaced or substituted by other components or equivalents, appropriate results may be achieved.

Therefore, other implementations, other embodiments, and equivalents of the claims are within the scope of the following claims.

What is claimed is:

1. A data visualization method comprising:
displaying a first user interface (UI) providing a list related to a plurality of basic data on a display;
in correspondence to a first input obtained through the first UI, displaying on a display a second UI providing a list related to a plurality of items included in first basic data corresponding to the first input among the plurality of basic data;
in correspondence with one or more item inputs obtained through the second UI, extracting one or more sub data respectively corresponding to the one or more item inputs;
generating first visualization data based on the extracted one or more sub data; and
displaying a third UI comprising the first visualization data on the display.

2. The data visualization method of claim 1, further comprising:
displaying an initial UI providing a list related to a plurality of categories on the display; and
in correspondence to an initial input obtained through the initial UI, extracting a list related to the plurality of basic data corresponding to the initial input from among the plurality of categories.

3. The data visualization method of claim 1, wherein generating the first visualization data comprises:
checking data attributes of the one or more sub data;
selecting a first template from among a plurality of previously stored templates based on the data attributes; and
generating the first visualization data by inputting the one or more sub data into the first template.

4. The data visualization method of claim 3, wherein the data attributes include at least one of location check, numerical value check, numerical value comparison, correlation analysis of a numerical value, distribution check, or trend check.

5. The data visualization method of claim 1, wherein the one or more item inputs are implemented through a click or a drag and drop.

6. The data visualization method of claim 1, wherein the plurality of basic data comprise data obtained from a server of a public institution.

7. The data visualization method of claim 3, wherein the plurality of previously stored templates include at least one of a map, a graph, a distribution chart, a flowchart, text, an image, or a link.

8. The data visualization method of claim 1, further comprising:
including the first visualization data in the plurality of basic data;
displaying, on the display, a fourth UI providing a list related to the plurality of basic data including the first visualization data; and
in correspondence to a second input obtained through the fourth UI, displaying, on the display, a fifth UI providing a list related to a plurality of items included in second basic data corresponding to the second input among the plurality of basic data including the first visualization data.

9. The data visualization method of claim 8, wherein the plurality of items included in the second basic data include a plurality of items included in the first basic data and one or more items corresponding to the one or more item inputs.

10. A data visualization system comprising:
a processor configured to process data; and
a display configured to output the processed data,
the processor further configured to:
display a first user interface (UI) providing a list related to a plurality of basic data on a display,
in correspondence to a first input obtained through the first UI, display on a display a second UI providing a list related to a plurality of items included in first basic data corresponding to the first input among the plurality of basic data,
in correspondence with one or more item inputs obtained through the second UI, extract one or more sub data respectively corresponding to the one or more item inputs,
generate first visualization data based on the extracted one or more sub data, and
display a third UI comprising the first visualization data on the display.
